(19) United States
(12) Patent Application Publication
(10) Pub. No.: US 2004/0207914 A1
(43) Pub. Date: Oct. 21, 2004

(54) Imaging system having a dual cassegrain-like format

(76) Inventor: Allan David Beach, Christchurch (NZ)

Correspondence Address: DANN, DORFMAN, HERRELL & SKILLMAN, saet, 1601 MARKET STREET, PHILADELPHIA, PA, 19103-2307, US

(21) Appl. No.: 10/474,993

(22) PCT Filed: Apr. 22, 2002
(86) PCT No.: PCT/NZ02/00070

(30) Foreign Application Priority Data
Apr. 20, 2001 (NZ) 511257

(51) Int. Cl. G02B 17/00

(52) U.S. Cl. 359/365; 359/727

(57) ABSTRACT

An optical imaging system (100) has a Cassegrain-like front end (1) with a substantially spherical concave primary mirror (3) and a substantially spherical convex secondary mirror (4), a Cassegrain-like rear end (2) with a substantially spherical concave primary mirror (7) and a substantially spherical convex secondary mirror 8, and a field lens system (5) to image the aperture stop of the rear end to a position where it forms the entrance pupil of the optical imaging system (100). An aberration corrector (6) may be provided to correct selected aberrations.

### TECHNICAL FIELD

The present invention relates to an optical imaging system and in particular, but not exclusively, to an optical imaging system suitable for use in measurement of relative locations of objects within the optical field.

### BACKGROUND

Imaging performance of an optical imaging system can be expressed as some combination of the following parameters:

Numerical Aperture (N.A.) or “speed”—for low-light-level capability;

Field angle—for the biggest picture;

Angular resolution—for the sharpest picture;

Spectral bandpass—for multi-spectral capability;

Pupil diameter—for the highest (appropriate) upper limit of light-gathering power; and

Transmission losses.

The planar nature of solid-state imaging devices dictates the need for flat-field imaging optics; hence, a further desirable characteristic is a flat focal surface.

Also, the limited lateral dimensions of solid state imaging devices relative to those of photographic emulsion substrates, require shorter focal lengths in order to achieve useful field angles. These specifics are in conflict with the characteristics of optical imaging systems with large pupil diameters, because of the ensuing high N.A. values, and the associated difficulties of aberration control and elimination of residual curvature of the focal surface.

Of the many other desirable characteristics, three are of some importance to an elegant solution:

Compactness, for opto-mechanical efficiency.

Rear access to the image surface, for operational adaptability.

Spherical mirrors, for low cost and ease of alignment maintenance.

The problem of aberration control is exacerbated if spherical mirrors are chosen for the system, because of the constraints placed on the available degrees of freedom.

Optical systems for imaging substantially parallel incident light have been produced in many different formats, depending on the performance requirements of the system. For example, some applications require imaging systems with very low aberrations, while others may require a relatively fast imaging system, and others still require a relatively wide useful angular field. Often, these characteristics must be traded against each other in order to design a system, which overall best meets the imaging requirements.

In some applications, precise measurement of relative locations in the optical field is required. Digital imaging devices have been used for this purpose due to allowing identification of the individual pixel locations of each object, after which measurement of the separation of the objects in the image is simplistic. However, these systems are limited in accuracy to the resolution of a digital imaging device.

In optical metrology applications, the objects of interest may be treated as point sources, which may be used as fiducial markers. Analysis of the image resulting from the treatment of the objects in this way enables sub-pixel dimensional measurements and thus a very high angular resolution for the system.

A problem with treating objects as point sources in this way, is that the optical system used to create the image on the digital imaging device may itself introduce higher errors into the system than the digital imaging device. Therefore, an imaging device having low aberrations is required, but also the system must have a usefully wide angular field and a high light-gathering power.

### OBJECT OF THE INVENTION

Thus, it is an object of the present invention to provide an optical system with a high image quality and wide angular field for use in applications requiring accurate relative location measurements, thereby overcoming or alleviating problems present in current imaging systems or that at least provides the public with a useful choice.

Further objects of the present invention may become apparent from the following description.

### SUMMARY OF THE INVENTION

Throughout this specification, the term “Cassegrain-like” has been used in reference to an imaging system for receiving substantially parallel incident light, which includes a concave primary mirror and a convex secondary mirror located relative to the primary mirror so as to precede the focal plane of the primary. The use of “Cassegrain-like” is not intended to be limited to describing solely a traditional Cassegrain format with a paraboloid primary mirror and a hyperboloid secondary mirror.

According to one aspect of the present invention, there is provided an optical imaging system including: a Cassegrain-like front end imaging system including a substantially spherical concave primary mirror and a substantially spherical convex secondary mirror; a Cassegrain-like rear end imaging system including a substantially spherical concave primary mirror and a substantially spherical convex secondary mirror; and a transfer means to image the aperture stop of the rear end imaging system to a position where it forms the entrance pupil of the optical imaging system.

Preferably, the aperture of the optical system is located at the aperture stop of the rear end imaging system.

Preferably, the optical system further includes a detecting means to detect an image from the rear end imaging system.

Preferably, the detecting means includes a digital detector.

The optical system may include a field flattener to adapt the image for detection by a planar detector.

Preferably, the rear end imaging system is adapted to function as a focal enlarger.

Preferably, the rear end imaging system has a speed slower than the front end imaging system, thereby creating a telephoto effect.

In a preferred embodiment, all surfaces of the optical system's optical imaging components, except one, are substantially spherical. All optical components, except one, may be sub-aperture components.

The image transfer means is preferably a field lens system. The field lens system may consist of a single lens, or may be a multiple-component lens. The field lens system preferably comprises a doublet lens and a transfer meniscus.

Preferably, the front end imaging system and the rear end imaging system may be substantially complementary, whereby selected aberrations introduced into an image by the front end imaging system are at least partly cancelled by substantially like and opposite aberrations introduced by the rear end imaging system.

Preferably, the front end and the rear end imaging systems may be adapted so as to be substantially complementary in respect of selected aberrations over field angles up to approximately 0.75 degrees off-axis.

Preferably, the radii and separations of the optical system's mirrors are balanced against each other to minimize monochromatic optical aberrations.

Preferably, at least selected aberrations that are not substantially cancelled by the complementary arrangement of the front and rear end imaging systems may be corrected using aberration correcting means, which is preferably present in the rear end imaging system.

Preferably, the aberration correcting means may include one or more lenses.

The aberration correcting means may be adapted to correct for spherical aberration introduced by said substantially spherical reflecting elements. The aberration correcting means may include a lens having an aspheric surface located substantially at the aperture stop of the optical system, to correct for spherical aberration.

Preferably, said correcting means may include a doublet or triplet lens, or other similar multiple-component lens subsystem containing an arbitrary number of elements that are optically in contact (having cemented surfaces) and/or elements that are separated by some finite air space.

In one preferred embodiment, two lens components of the multiple-component lens may be adapted to compensate for chromatic error introduced by other reflective components in the optical system, and the third lens component adapted to correct for spherical aberration.

Preferably, the two lens components which are adapted to compensate for chromatic error are manufactured from Schott N-PK51 and KZFN2 glasses, and the third lens component is manufactured from silica The lens components are preferably separated by a finite air space. Other component combinations may be used in a similar manner for multiple-lens subsystems.

Preferably, the correcting means may be adapted to correct for zonal aberrations.

According to another aspect of the present invention, there is provided a method of imaging substantially parallel incident light onto a detecting means, the method including: receiving incident light in a front end imaging system including a substantially spherical concave primary mirror and a substantially spherical convex secondary mirror arranged in a Cassegrain-like format; transferring the image from said front end imaging system to a rear end imaging system including a substantially spherical concave primary mirror and a substantially spherical convex secondary mirror arranged in a Cassegrain-like format; and receiving an image from the rear end imaging system by the detecting means.

Preferably, the method may include, for selected aberrations, introducing aberrations in the rear end imaging system that are like and opposite the aberrations introduced in the image by the front end imaging system

Preferably, the method may include introducing said like and opposite aberrations only in relation to field angles up to approximately 0.75 degrees off-axis.

Preferably, the method includes balancing the radii and separations of the imaging system's mirrors against each other in such a way as to minimize monochromatic aberrations.

Preferably, the method may further include correcting for spherical aberration introduced by said front end and/or said rear end substantially at an aperture stop of the front end imaging system and rear end imaging system combined.

Preferably, the step of transferring the image from said front end imaging system to a rear end imaging system may include imaging the aperture stop of the rear end imaging system to a position where it forms the entrance pupil of the optical imaging system.

According to another aspect of the present invention, there is provided a method of measuring relative locations of objects that may be treated as point sources, the method including: receiving light from said objects using a first Cassegrain-like imaging system including a substantially spherical concave primary mirror and a substantially spherical convex secondary mirror, transferring an image from the first Cassegrain-like imaging system to a second Cassegrain-like imaging system including a substantially spherical concave primary mirror and a substantially spherical convex secondary mirror, receiving an image from said second Cassegrain-like imaging system by a detecting means and determining the relative locations of the objects by determining the separation of the objects within the image received by the detecting means.

Preferably, the method may include, for selected aberrations, introducing in the second Cassegrain-like imaging system substantially equal and opposite aberrations to the aberrations that would be introduced in the image received by the detecting means by the first Cassegrain-like imaging system.

Preferably, the method may include using a digital detector and determining within which pixel or pixels each object is located.

Preferably, the method may include determining the location within a pixel of an imaged object.

This invention may also be said broadly to consist in the parts, elements and features referred to or indicated in the specification of this application, individually or collectively, and any or all combinations of any two or more said parts, elements or features, and where specific integers are mentioned herein which have known equivalents in the art to which this invention relates, such known equivalents are deemed to be incorporated herein as if individually set forth.

Further aspects of the present invention may become apparent from the following description, which is given by way of example only and in reference to the accompanying drawings.

### BRIEF DESCRIPTION OF THE DRAWINGS

FIG. 1: Shows a diagrammatic representation of an optical system according to one aspect of the present invention.

FIG. 2: Shows a logarithmic display of the point spread function of an example of an optical system according to the present invention on-axis.

FIG. 3: Shows a logarithmic display of the point spread function of the same optical system of FIG. 2 at 0.5° off-axis.

FIG. 4 Shows a logarithmic display of the point spread function of the same optical system of FIG. 2 at 0.75° off-axis.

FIG. 5: Shows a graph of the uniformity of modulation transfer function of the same optical system of FIG. 2 across an angular field up to 0.75°.

### DETAILED DESCRIPTION OF THE PREFERRED EMBODIMENT

The optical system of the present invention includes two Cassegrain-like (as hereinbefore defined) imaging systems, with one located at the front end of the optical system to receive light from the objects to be imaged and the second located at the rear end of the optical system to receive light from the front end and image it onto a suitable detecting means. The front end and rear end may be designed so that the rear end introduces like and opposite aberrations to the front end, thereby at least partly cancelling selected aberrations. Other aberrations may be corrected using one or more correcting elements.

Thus, it is anticipated that the optical system of the present invention may be used in applications where low aberrations in the image are important In particular, the present invention may have application to the measurement of relative locations of distant objects in optical metrology, as the resulting system typically has a relatively wide angular field. More particularly, the optical system of the present invention may be used with a digital detector for analysis using sub-pixel dimensional measurements.

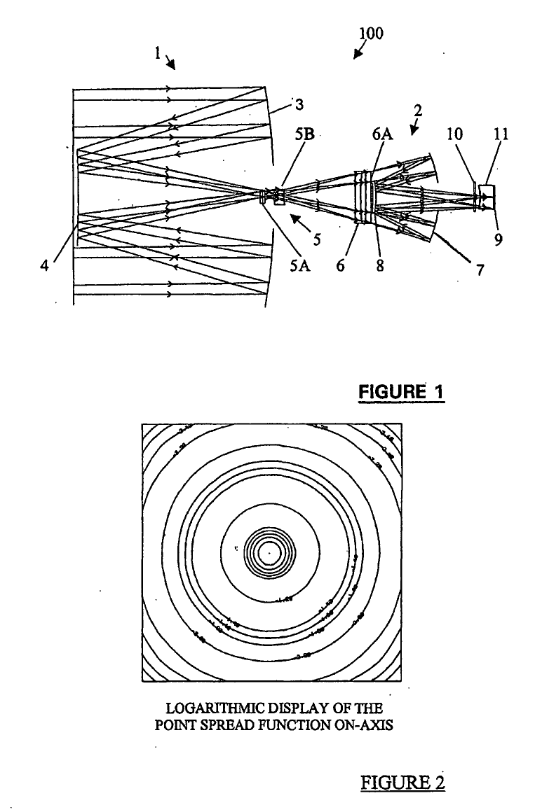

Referring to FIG. 1, a diagrammatic representation of an optical system according to one preferred embodiment of the present invention is shown. For simplicity, only the reflecting and refracting elements of the system are shown, together with the detector. It will be immediately apparent to those skilled in the art that various support structures will be required for the reflecting and refracting elements within the optical system and a baffle may be included to prevent interference from light sources surrounding the optical system.

An optical system according to the present invention is generally referenced by arrow 100 and includes a front end 1 and a rear end 2. The front end 1 includes a primary mirror 3 and a secondary mirror 4, both of which are spherical to enable high precision fabrication advantageous alignment characteristics, and reduced cost. The preferred embodiment of the system includes appropriate correcting means for spherical aberration, to provide improved image quality.

An image transfer means in the form of a field lens system 5 is located near the image of the front end 1 and has a function to image the aperture stop of the rear end imaging system 2 to a position where it forms the entrance pupil of the optical imaging system. In the embodiment shown in FIG. 1, the field lens system includes a doublet lens 5A and a transfer meniscus 5B. The doublet lens 5A is so constructed as to correct any lateral chromatic aberration due to the refractive elements of the optical system 100. Other single or multiple-component lens subsystems could be used for the field lens system. Air gaps may be provided between the multiple components, or the multiple components may be cemented directly together.

An aberration correcting means, such as triplet lens 6 is provided at or near the aperture stop of the rear end 2. In particular, the rear face 6A of the triplet lens 6 is located substantially at the aperture stop of the optical system 100, which coincides with the entrance pupil of the rear end 2. The rear face 6A of the triplet lens 6 is figured to an aspheric shape to compensate for spherical aberration introduced by the spherical mirrors of the front end 1 and the rear end 2. The other two lens components of the corrector triplet 6 are adapted to correct for axial chromatic aberration introduced by the other refractive components of the optical system 100. The triplet lens 6 may also be used to correct for zonal aberrations in the image.

It will be appreciated by those skilled in the art that the correcting means may be implemented in various forms other than through a triplet lens located substantially at the aperture stop of the system. These may include other single or multiple-lens subsystems or alternative and/or additional refractive or reflective components located at various positions. The positioning of the triplet at the aperture stop is the preferred embodiment to avoid further aberrations being introduced by the correcting lens system.

The rear end 2 includes a primary mirror 7 and secondary minor 8 which are spherical and are arranged in a Cassegrain-like (as hereinbefore defined) format. After the rear end 2 receives an image from the field lens system 5 at the entrance pupil of the rear end 2, this image is re-imaged by the primary mirror 7 and secondary mirror 8 to form an image on a detector 9. A filter 10 and field flattener 11 may be provided in the optical path immediately preceding the detector 9 in order to adapt the image to be suitable for detection by a planar imaging device.

An air gap is provided between the field flattener and the detector to prevent damage due to contact between the two.

The detector 9 may be any suitable detector, but it is envisaged that the optical system 100 has particular application to digital detectors, and more particularly to digital detectors used for the purpose of determining the relative locations of objects within the optical field.

A key feature of the optical system 100 is its ability to be designed so that high-order aberrations introduced by the front end 1 are at least partly cancelled by introducing equal and opposite aberrations in the rear end 2 and vice versa.

It will be appreciated by those skilled in the art that the required curvature, relative locations and any modification of the primary and secondary mirrors of the front end 1 and rear end 2 may be optimally computed using an optimisation algorithm constrained to negate specific aberrations introduced by the mirror components, such as coma and astigmatism. The radii and separations of the optical system's reflecting elements are preferably balanced against each other to minimize monochromatic optical aberrations.

Further aberrations such as spherical aberration, which occurs when spherical mirrors are used, are corrected by other components within the system, particularly the aspheric surface of the rear face 6A of the triplet lens 6. Colour correction is also achieved by the triplet lens 6 and the image is adapted for detection by a planar detector if required by a filter 10 and field flattener 11. It will be understood that the corrector may include a single lens with an aspheric surface to correct for spherical aberration.

The rear end 2 acts as a focal enlarger and thus has a speed slower than the front end 1. This allows the optical system 100 to be more compact than many existing systems. The focal ratio of the primary mirror 3 is the first factor determining the size of the optical system 100. The use of a long radius secondary mirror 4 does not overly slow the optical system 100. The rear end 2, arranged in a Cassegrain-like format, is compact and is relatively slow

### EXAMPLE SYSTEM

Table 1 shows an example optical imaging system having the layout of FIG. 1. The radius and curvature of each surface, thickness (or distance to the next surface), element type, and element diameter are shown in Table 1. The design was adjusted to provide an image scale of 1 arcsecond per 9 microns, in order to complement a digital detector having a 9 micron pixel size.

TABLE 1
Example System

| | | Radius | Thickness | | Diameter |
|---|---|---|---|---|---|
| Surface | Comment | mm | mm | Glass | mm |
| 1 | Central Obstruction | | 410.00 | | 197.0 |
| 2 | Primary Mirror 3 | −1360.000 | −400.00 | MIRROR | 452.0 |
| 3 | Secondary Mirror 4 | −2042.000 | 369.59 | MIRROR | 197.0 |
| 4 | Transfer- | 82.090 | 6.00 | SK16 | 27.0 |
| 5 | Doublet 5A | −400.000 | 5.00 | F2 | 27.0 |
| 6 | | 188.690 | 18.29 | | 27.0 |
| 7 | Transfer Meniscus 5B | 78.336 | 20.48 | KZFN2 | 29.7 |
| 8 | | 54.100 | 144.16 | | 31.3 |
| 9 | Corrector- | Infinity | 10.00 | N-PK51 | 106.0 |
| 10 | Triplet 6 | 360.800 | 12.00 | KZFN2 | 106.0 |
| 11 | Asphere Substrate | Infinity | 10.00 | SILICA | 106.0 |
| 12 | Asphere SAG = 31.2 UM | Infinity | 4.00 | | 104.8 |
| 13 | | Infinity | 131.85 | | 60.0 |
| 14 | Rear End Primary 7 | −234.685 | −125.85 | MIRROR | 182.2 |
| 15 | Rear End Secondary 8 | −158.200 | 196.08 | MIRROR | 66.9 |
| 16 | Filter 10 | Infinity | 3.00 | BK7 | 60.0 |
| 17 | | Infinity | 10.00 | | 60.0 |
| 18 | Field Flattener 11 | −93.119 | 27.59 | LAK21 | 44.8 |
| 19 | | Infinity | 2.00 | | 48.6 |
| 20 | Image | Infinity | 0.00 | | 49.1 |
| | Aspheric coefficients of | A2 | A4 | A6 | A8 |
| | surface 12 | −5.11E−05 | 2.32E−08 | −1.92E−12 | 7.36E−17 |

| | |
|---|---|
| Entrance pupil diameter | 400 mm |
| Entrance pupil position | −1674.500 |
| Image scale | 1 arcsec/9 microns |
| Linear image diameter | 98.2 mm |
| Spectral passband | 450-900 mm |
| Field angle | 1.5 degrees |
| Focal ratio | 4.64 |

Also shown in Table 1 are the aspheric coefficients for the rear face of the triplet lens 6. The aspheric coefficients of the standard asphere function Z, are shown in equation 1. For this system, the first eight coefficients were used and optimised, with the result that the odd coefficients were zero.

$$Z = \frac{{cr}^{2}}{1 + \sqrt{1 - ( 1 + k ) {c}^{2} {r}^{2}}} + ( A1 ) {r}^{2} + ( A2 ) {r}^{4} + ( A3 ) {r}^{6} + ( A4 ) {r}^{8} + … \qquad equation 1$$

In the above equation, “Z” is the axial distance; “c” is the radius of the surface; “r” is the radius of the zone; “k” is the conic constant.

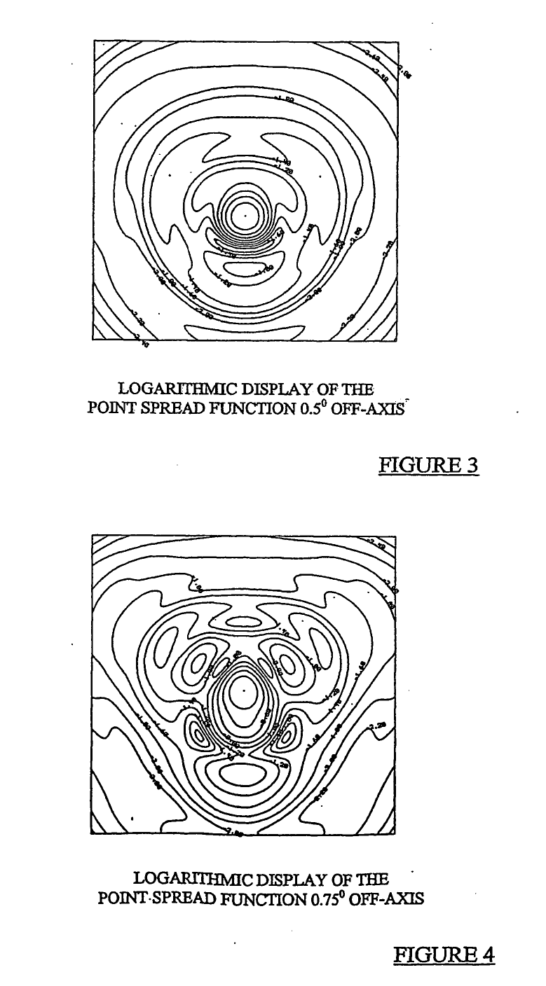

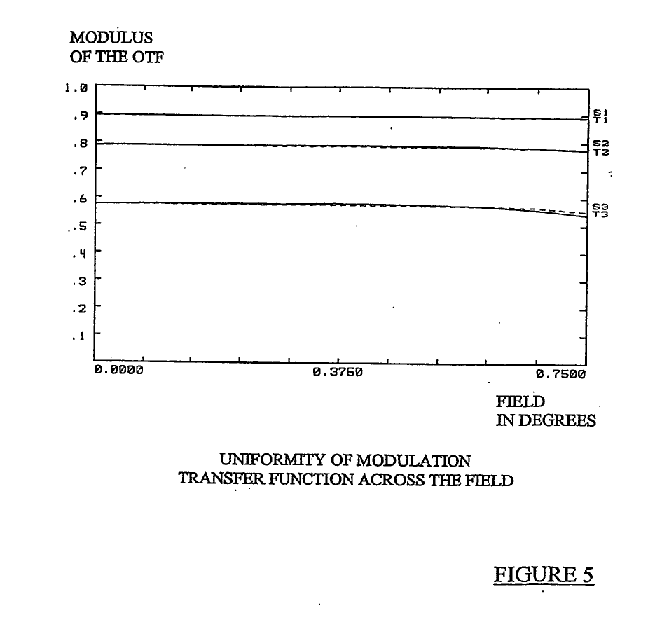

FIG. 2 shows a logarithmic plot of the polychromatic log FFT point spread function for the optical system shown in FIG. 1 and as defined in Table 1. This plot shows the point spread function on-axis. FIGS. 3 and 4 show the point spread function at 0.5° and 0.75° off-axis respectively. FIG. 5 shows a plot of the uniformity of modulation across the field. FIGS. 2 to 5 show the results for the system defined in Table 1. Each plot represents a 20 micron square image, with a logarithmic contour display that enhances the “skis” of the residual blur. At 0°, 0.5°, and 0.75° off-axis angles, the residual aberrations exhibit a symmetry and focal concentration that it enables significant sub-pixel-dimension centroid determination, resulting in very high angular resolution of the optical system.

The relatively slow speed of the rear end of the system provides good angular resolution The system has high levels of aberration correction and symmetrical high-order residual aberrations, providing very high resolution within a diffraction limited system.

The focusing power of the preferred optical system resides in the spherical mirrors, avoiding the major chromatic errors associated with powered refractive components. Also, only one of the optical components is full aperture-diameter, resulting in cost advantages. The system is relatively compact, enabling a rigid and easily mounted opto-mechanical assembly.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention.

For example, while the mirrors of the preferred embodiment are described as being spherical, they could be modified slightly whilst still achieving the desired result.

While not shown in the diagrams, a tilted mirror could be provided in the system to deflect the focus of the system and may, for example, deflect the entire rear end of the system to one side. The tilted mirror may be oriented so that the rear end is deflected by an angle between 0 degrees and possibly up to greater than 90 degrees. The tilted mirror could alternatively be positioned elsewhere in the system to deflect the focus.

1. An optical imaging system comprising:
a Cassegrain-like front end imaging system including a substantially spherical concave primary mirror and a substantially spherical convex secondary mirror; and
a Cassegrain-like rear end imaging system including a substantially spherical concave primary mirror and a substantially spherical convex secondary mirror; and
an image transfer means to image the aperture stop of the rear end imaging system to a position where it forms the entrance pupil of the optical system.

2. The optical system as claimed in claim 1 wherein the aperture of the optical system is located at the aperture stop of the rear end imaging system.

3. The optical system as claimed in claim 1, further including a detecting means to detect an image from the rear end imaging system.

4. The optical system as claimed in claim 3, wherein the detecting means includes a digital detector.

5. The optical system as claimed in claim 1, including a field flattener to adapt the image for detection by a planar detector.

6. The optical system as claimed in claim 1, wherein the rear end imaging system is adapted to function as a focal enlarger.

7. An optical system as claimed in claim 1, wherein the rear end imaging system has a speed slower than the front end imaging system.

8. An optical system as claimed in claim 1, wherein all surfaces of the optical system's optical imaging components, except one, are substantially spherical.

9. An optical system as claimed in claim 1, wherein all optical components, except one, are sub-aperture components.

10. The optical system as claimed in claim 1, wherein the image transfer means is a field lens system.

11. The optical system as claimed in claim 10, wherein the field lens system includes a multiple-component lens.

12. The optical system as claimed in claim 11, wherein the field lens system includes a doublet lens and a transfer meniscus.

13. An optical system as claimed in claim 1, wherein the front end and rear end imaging systems are substantially complementary, such that selected aberrations introduced into an image by the front end imaging system are at least partly cancelled by substantially like and opposite aberrations introduced by the rear end imaging system.

14. An optical system as claimed in claim 13, wherein the front end and the rear end imaging systems are adapted so as to be substantially complementary in respect of selected aberrations over field angles up to approximately 0.75 degrees off-axis.

15. An optical system as claimed in claim 13, wherein the radii and separations of the optical system's mirrors are balanced against each other to minimize monochromatic aberrations.

16. The optical system as claimed in claim 13, wherein selected aberrations that are not substantially cancelled by the complementary arrangement of the front and rear end imaging systems may be corrected using aberration correcting means.

17. An optical system as claimed in claim 16, wherein the aberration correcting means is present in the rear end imaging system.

18. An optical system as claimed in claim 16, wherein the aberration correcting means includes one or more lenses.

19. The optical system as claimed in claim 16, wherein the aberration correcting means is adapted to correct for spherical aberration introduced by said substantially spherical mirrors of the front end and rear end imaging systems.

20. An optical system as claimed in claim 16, wherein the aberration correcting means includes a lens having an aspheric surface located substantially at the aperture stop of the optical system, to correct for spherical aberrations.

21. An optical system as claimed in claim 16, wherein said aberration correcting means includes a multiple-component lens.

22. An optical system as claimed in claim 21, wherein two lens components of the multiple-component lens are adapted to compensate for chromatic error introduced by other reflective components in the optical system, and a third lens component is adapted to correct for spherical aberration.

23. An optical system as claimed in claim 22, wherein the two lens components which are adapted to compensate for chromatic error are manufactured from N-PK51 and KZFN2 glasses, and the third lens component is manufactured from silica.

24. An optical system as claimed in claim 23, wherein the lens components of the multiple-component lens are separated by a finite air space.

25. An optical system as claimed in claim 16, wherein the aberration correcting means is adapted to correct for zonal aberrations.

26. A method of imaging substantially parallel incident light onto a detecting means, the method including: receiving incident light in a front end imaging system including a substantially spherical concave primary mirror and a substantially spherical convex secondary mirror arranged in a Cassegrain-like format;
transferring the image from said front end imaging system to a rear end imaging system including a substantially spherical concave primary mirror and a substantially spherical convex secondary mirror arranged in a Cassegrain-like format; and
receiving an image from the rear end imaging system by the detecting means.

27. The method as claimed in claim 26, including, for selected aberrations, introducing like and opposite aberrations in the rear end imaging system to correct for aberrations introduced in the image by the front end imaging system.

29. The method as claimed in claim 27, including balancing the radii and separations of the imaging system's mirrors against each other in such a way as to minimize monochromatic aberrations.

30. The method as claimed in claim 26, including correcting for spherical aberration introduced by said front end and/or said rear end substantially at an aperture stop of the front end imaging system and rear end imaging system combined.

31. The method as claimed in claim 26, wherein the step of transferring the image from said front end imaging system includes imaging the aperture stop of the rear end imaging system to a position where it forms the entrance pupil of the optical imaging system.

32. A method of measuring relative locations of objects that may be treated as point sources, including:
receiving light from said objects using a first Cassegrain-like imaging system including a substantially spherical concave primary mirror and a substantially spherical convex secondary mirror;
transferring an image from the first Cassegrain-like imaging system to a second Cassegrain-like imaging system including a substantially spherical concave primary mirror and a substantially spherical convex secondary mirror;
receiving an image from the second Cassegrain-like imaging system by a detecting means; and
determining the relative locations of the objects by determining the separation of the objects within the image received by the detecting means.

33. The method as claimed in claim 32 including, for selected aberrations, introducing in the second Cassegrain-like imaging system substantially equal and opposite aberrations to the aberrations that would be introduced in the image received by the detecting means by the first Cassegrain-like imaging system.

34. The method as claimed in claim 32, including using a digital detector, and determining within which pixel or pixels of the detector each object is located.

35. The method as claimed in claim 32, including determining the location within a pixel of an imaged object.

36. (Canceled)

37. (Canceled)

38. (Canceled)

39. (Canceled)
